(19) United States
(12) Patent Application Publication
(10) Pub. No.: US 2023/0111602 A1
(43) Pub. Date: Apr. 13, 2023

(54) ABNORMALITY DETERMINATION SYSTEM, IMAGING DEVICE AND ABNORMALITY DETERMINATION METHOD

(71) Applicant: NEC Corporation, Minato-ku, Tokyo (JP)

(72) Inventor: Hiroshi IMAI, Tokyo (JP)

(73) Assignee: NEC Corporation, Minato-ku, Tokyo (JP)

(21) Appl. No.: 17/908,019

(22) PCT Filed: Mar. 9, 2020
(86) PCT No.: PCT/JP2020/009914

§ 371 Date: Aug. 30, 2022

(51) Int. Cl. G02B 17/06; G06T 7/00; G02B 5/04

(52) U.S. Cl. CPC G02B 17/06; G06T 7/0004; G02B 5/04

(57) ABSTRACT

An imaging device outputs time series images that include multiple captured images that capture over time the surface of the object to be measured. On the optical path extending from the object to be measured, through a lens equipped on the imaging device and up to the imaging surface, the optical path bending member is interposed in a part of the optical path between the object to be measured and a lens. The optical path bending member bends the light traveling from the lens to the imaging surface so as to tilt the light in a direction such that the direction of travel thereof approaches the optical axis of the lens. This abnormality determination device utilizes the in-plane displacement and out-of-plane displacement calculated from the time series images to determine abnormalities in the measured object.

### TECHNICAL FIELD

The present invention relates to a technique for detecting abnormalities such as a crack on a surface of an object in a non-contact manner.

### BACKGROUND ART

In structures such as tunnels and bridges and components constituting the structures, flaws such as a crack, peeling, or an internal cavity generated on their surfaces can adversely affect soundness of the structures. Therefore, it becomes necessary to accurately detect such a flaw as an abnormality as soon as possible.

As a method of detecting such a flaw, there is a method of detecting a flaw of a structure by an inspector performing visual inspection or hammering test. This method has a problem that it takes a lot of time and labor cost.

A method of determining a state of a structure using a captured image obtained by capturing the structure has been proposed. For example, PTL 1 discloses a method for detecting flaws of a structure using image characteristics of the flaws such as a crack obtained in advance from a binarized image generated by binarizing an image obtained by capturing the structure with a camera.

Furthermore, PTL 2 and 3 disclose techniques for detecting flaws of a structure based on stress generated in the structure. Furthermore, PTL 4 and 5 disclose techniques for detecting flaws of an object from a moving image obtained by capturing the object with one camera. In the techniques in PTL 4 and 5, displacement in a direction along a surface on the surface of an object (also referred to as in-plane displacement) and displacement in a direction along an optical axis direction of a camera (also referred to as out-of-plane displacement) are detected. Furthermore, in the techniques in PTL 4 and 5, flaws (abnormalities) of objects such as a crack, peeling, and an internal cavity are detected based on the detected out-of-plane displacement and in-plane displacement.

Furthermore, NPL 1 discloses a method for measuring in-plane displacement from a moving image obtained by capturing a surface of a structure.

### CITATION LIST

### Patent Literature

[PTL 1] JP 2003-035528 A
[PTL 2] JP 2008-232998 A
[PTL 3] JP 2006-343160 A
[PTL 4] WO 2016/152075 A1
[PTL 5] WO 2017/152076 A1

### Non Patent Literature

[NPL 1] Z. Wang, et al., “Crack-opening displacement estimation method based on sequence of motion vector field images for civil infrastructure deterioration inspection”, Image Media Processing Symposium (PCSJ/IMPS 2014), I-1-17, The Institute of Electronics, Information and Communication Engineers, Nov. 12, 2014

### SUMMARY OF INVENTION

### Technical Problem

In the techniques of PTL 4 and 5, in-plane displacement and out-of-plane displacement of an object are calculated from a captured image by one camera, and a flaw of the object is detected using the calculated in-plane displacement and out-of-plane displacement. In order to increase detection accuracy in such an object flaw detection method, it is conceivable to increase measurement resolution of in-plane displacement and out-of-plane displacement. In order to increase the measurement resolution of in-plane displacement, it is conceivable to adjust the angle of view with a lens.

However, if the angle of view is adjusted with the lens in order to increase the measurement resolution of in-plane displacement, the measurement resolution of out-of-plane displacement deteriorates. That is, there is a problem that it is difficult to increase the measurement resolution of both in-plane displacement and out-of-plane displacement by adjusting the angle of view with the lens.

The present invention has been devised in order to solve the above problem. That is, a main object of the present invention is to provide a technique capable of facilitating increasing the measurement resolution of both in-plane displacement and out-of-plane displacement on the surface of an object and capable of increasing detection accuracy in detecting flaws on an object from a captured image.

### Solution to Problem

In order to achieve the above object, an abnormality determination system according to the present invention, as an aspect, includes:

an imaging device configured to output time series images that include a plurality of captured images in which a surface of an object to be measured is captured over time;

an optical path bending member that is interposed in an optical path part between the object to be measured and a lens equipped on the imaging device, on an optical path extending from the object to be measured through the lens to an imaging surface, and is configured to bend light traveling from the lens to the imaging surface so as to tilt light in a direction such that a direction of travel of the light approaches an optical axis of the lens; and

an abnormality determination device configured to determine an abnormality of the object to be measured using out-of-plane displacement, which is displacement in a normal direction on a surface of the object to be measured that is calculated using displacement of a surface of the object to be measured that has been measured from the time series images and in-plane displacement, which is displacement on a surface of the object to be measured that is calculated by subtracting the out-of-plane displacement from displacement of the surface of the object to be measured that has been measured.

An imaging device according to the present invention, as an aspect, includes:

an imaging surface for capturing an image of a surface of an object to be measured;

a lens configured to guide light from an outside to the imaging surface; and

an optical path bending member that is interposed in an optical path part between the object to be measured and the lens on an optical path extending from the object to be measured through the lens to the imaging surface, and is configured to bend light traveling from the lens to the imaging surface so as to tilt light in a direction such that a direction of travel of the light approaches an optical axis of the lens.

An abnormality determination method according to the present invention, as one mode, includes:

interposing an optical path bending member configured to bend light traveling from a lens equipped on an imaging device to an imaging surface equipped on the imaging device so as to tilt the light in a direction such that a direction of travel of the light approaches an optical axis of the lens in an optical path part between the lens and a surface of the object to be measured, the imaging device outputting time series images that include a plurality of captured images in which the surface of the object to be measured is captured over time; and

determining an abnormality of the object to be measured using out-of-plane displacement, which is displacement in a normal direction on a surface of the object to be measured that is calculated using displacement of a surface of the object to be measured that is measured from the time series images based on light having traveled the imaging surface through the optical path bending member and the lens in order, and in-plane displacement, which is displacement on a surface of the object to be measured that is calculated by subtracting the out-of-plane displacement from displacement of the surface of the object to be measured that is measured.

### Advantageous Effects of Invention

According to the present invention, it is possible to facilitate increasing the measurement resolution of both in-plane displacement and out-of-plane displacement on a surface of an object and to increase detection accuracy in detecting flaws on an object from a captured image.

### BRIEF DESCRIPTION OF DRAWINGS

FIG. 1 is a block diagram explaining a configuration of an abnormality determination system of a first example embodiment of the present invention.

FIG. 2 is a block diagram explaining a configuration of an imaging device constituting the abnormality determination system of the first example embodiment.

FIG. 3 is a view explaining an example of an optical path in the abnormality determination system of the first example embodiment.

FIG. 4 is a view explaining a function of an optical path bending member in the first example embodiment.

FIG. 5A is a view expressing an example embodiment example of an optical path bending member.

FIG. 5B is a view expressing another example embodiment example of the optical path bending member.

FIG. 6 is a block diagram explaining a functional configuration of an abnormality determination device.

FIG. 7 is a block diagram explaining a function example of a determination unit in the abnormality determination device.

FIG. 8A is a view illustrating an optical arrangement on an XZ plane including an optical axis in imaging of an object to be measured.

FIG. 8B is a view illustrating an optical arrangement on a YZ plane including an optical axis in imaging of an object to be measured.

FIG. 9 is a view explaining an example of a method of calculating out-of-plane displacement.

FIG. 10A is a view explaining an example of an out-of-plane displacement vector of a surface of an object to be measured in a captured image.

FIG. 10B is a view expressing an example of a relationship between a length of the out-of-plane displacement vector and a distance from an imaging center.

FIG. 10C is a view expressing an example of a relationship between the length of the out-of-plane displacement vector and the distance from the imaging center in a case where the optical path bending member is interposed on an optical path.

FIG. 11 is a view explaining a measurement vector of displacement on a surface of an object to be measured that is measured from a time series image.

FIG. 12A is a view expressing an example of an object to be measured.

FIG. 12B is a view expressing an example of frequency characteristics of natural vibration of the object to be measured expressed in FIG. 12A.

FIG. 13A is a view explaining, together with FIG. 13B, in-plane displacement in a case where there is a crack on the surface of the object to be measured.

FIG. 13B is a view explaining, together with FIG. 13A, in-plane displacement in a case where there is a crack on the surface of the object to be measured.

FIG. 14A is a view illustrating an example of time change in in-plane displacement in a case where there is a crack on the surface of the object to be measured.

FIG. 14B is a view explaining an example of a relationship between a distance (position) from a crack and in-plane displacement in a case where there is a crack on the surface of the object to be measured.

FIG. 15 is a block diagram illustrating a hardware configuration example of an abnormality determination device.

FIG. 16 is a flowchart illustrating an example of abnormality determination processing executed by the abnormality determination device.

FIG. 17 is a block diagram expressing a configuration of an abnormality determination system of another example embodiment according to the present invention.

FIG. 18 is a block diagram expressing a configuration of an abnormality determination system of a second example embodiment according to the present invention.

FIG. 19 is a view explaining a configuration of an example embodiment of an imaging device according to the present invention.

### EXAMPLE EMBODIMENT

Example embodiments according to the present invention will be described below with reference to the drawings.

### First Example Embodiment

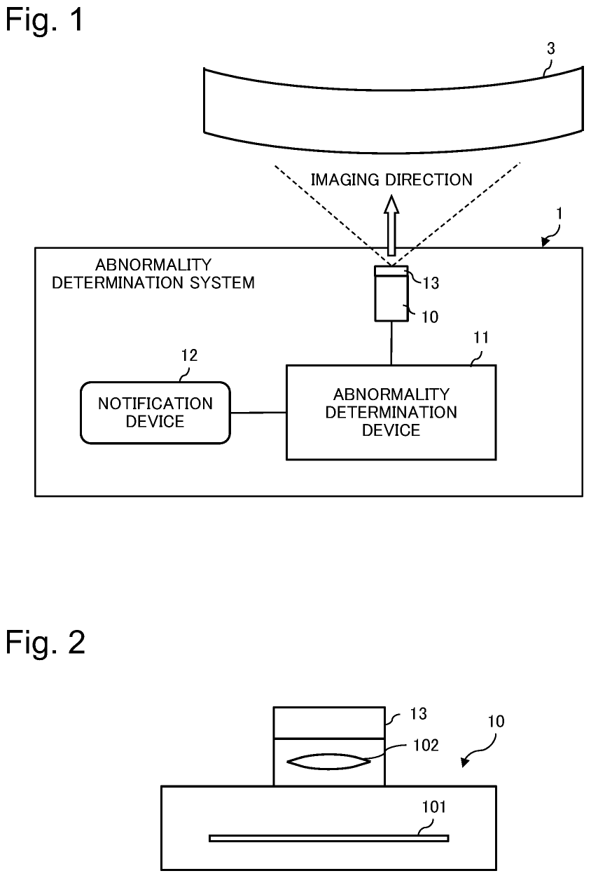

FIG. 1 is a block diagram expressing, together with an object to be measured, the configuration of the abnormality determination system of the first example embodiment according to the present invention. An abnormality determination system 1 of the first example embodiment includes a function of determining a crack, peeling on the surface of an object 3 to be measured and an internal cavity. The object 3 to be measured is a structure such as a building, a tunnel, or a bridge, or an object constituting a machine such as a car or a manufacturing device. Here, when measured by the abnormality determination system 1, the object 3 to be measured itself is not displaced by movement, rotational movement, or the like. However, the object bends or vibrates when applied with some force.

The abnormality determination system 1 includes an imaging device 10, an abnormality determination device 11, a notification device 12, and an optical path bending member 13. The imaging device 10 is a device that images the surface of the object 3 to be measured, and has a function of generating and outputting time series frame images (hereinafter, also referred to as time series images). The frame rate of the time series images is appropriately set within a range of 60 frames per second (fps) to 1000 fps, for example.

FIG. 2 is a block diagram expressing the configuration of the imaging device 10 together with the optical path bending member 13. The imaging device 10 is configured to include an imaging surface 101 and a lens 102. The imaging device 10 is integrally mounted with the optical path bending member 13. That is, the imaging surface 101, the lens 102, and the optical path bending member 13 are arrayed and arranged in this order, light enters the inside of the imaging device 10 through the optical path bending member 13, and the light reaches the imaging surface 101 on an optical path through the lens 102.

The imaging surface 101 has a configuration in which a plurality of imaging elements that convert light into electrical signals are arrayed and arranged in a matrix, and when image data is generated by the electrical signals output from each imaging element, a frame image is generated.

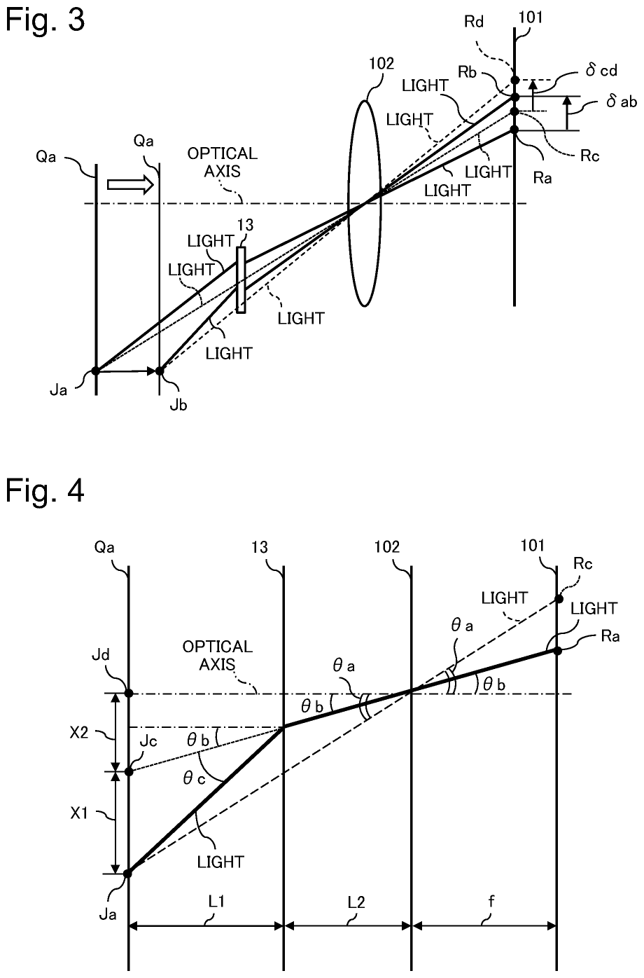

The optical path bending member 13 is has a configuration to bend the direction of travel of the light entering the imaging device 10 from the outside in a direction approaching the optical axis of the lens 102. FIGS. 3 and 4 illustrate specific examples of the optical path sequentially passing through the optical path bending member 13 and the lens 102 to reach the imaging surface 101. As illustrated in FIGS. 3 and 4, the optical path is bent by the optical path bending member 13. That is, assume that in the case of not providing the optical path bending member 13, as expressed by the dotted line in FIG. 4, light enters the lens 102 with an inclination of an angle θa with respect to the optical axis of the lens 102, and is further emitted from the lens 102. On the other hand, by providing the optical path bending member 13, as expressed by the solid line in FIG. 4, the light enters the lens 102 at an angle θb smaller than the angle θa with respect to the optical axis of the lens 102, and is emitted from the lens 102.

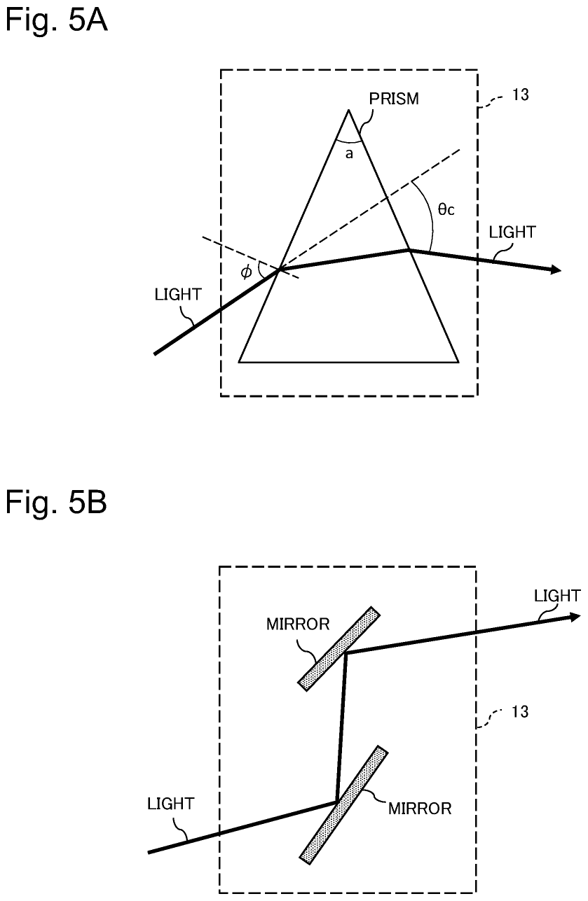

As described above, the configuration of the optical path bending member 13 is not limited as long as it can bend the optical path in a direction of approaching the optical axis of the lens 102. For example, it may be a triangular prism as expressed in FIG. 5A, or may be configured to have a mirror as expressed in FIG. 5B. In a case where the triangular prism as expressed in FIG. 5A is adopted as the optical path bending member 13, for example, the triangular prism is made of glass (refractive index n=1.5), and an apex angle a of the prism is 37°. Such a triangular prism is arranged such that an incident angle φ of light becomes 35°. In this case, a refraction angle θc of light in the triangular prism becomes 20°.

Here, the angle of view of the imaging device 10 in a case of providing the optical path bending member 13 will be described. For example, an angle of ½ of the angle of view of the lens 102 is θa expressed in FIG. 4. A refraction angle (deflection angle) of light by the optical path bending member 13 is θc. Furthermore, an angle formed between the optical path after the light entering the imaging device 10 is bent by the optical path bending member 13 and the optical axis of the lens 102 is θb. Furthermore, as expressed in FIG. 4, a distance (focal length) between the main surface of the lens 102 and the imaging surface 101 is f, a distance between the optical path bending member 13 and a surface Qa of the object 3 to be measured is L1, and a distance between the optical path bending member 13 and the main surface of the lens 102 is L2. Furthermore, on the surface Qa of the object 3 to be measured, a limit position of the visual field range of the imaging device 10 in a case of not providing the optical path bending member 13 is Ja. In the imaging device 10 including the optical path bending member 13, a position where a site of the position Ja on the surface Qa of the object 3 to be measured is imaged on the imaging surface 101 through the optical path bending member 13 and the lens 102 in order is Ra. A position where a virtual line passing through the main surface of the lens 102 from this position Ra is extended to reach the surface Qa of the object 3 to be measured is Jc. A length between Ja and Jc on the surface Qa of the object 3 to be measured is X1, and a length between an intersection point Jd and Jc with the optical axis of the lens 102 on the surface Qa of the object 3 to be measured is X2. In such a case, Formula 1 and Formula 2 are derived from the geometric relationship of light beam.

$$tan θ a = \frac{X 1 + X 2}{L 1 + L 2} \qquad ( Formula 1 )$$

$$X 1 + X 2 - L 2 \times tan θ b \times ( 1 - tan θ c \times tan θ b ) = L 1 \times ( tan θ c + tan θ b ) \qquad ( Formula 2 )$$

Formula 3 is derived by rewriting Formula 2 using Formula 1.

$$tan θ b = \frac{( L 1 + L 2 ) + \sqrt{\begin{matrix}{( L 1 + L 2 )}^{2} - 4 \times L 2 \times tan θ c \times \\ \{ ( L 1 + L 2 ) \times tan θ a - L 1 \times \text{?}\end{matrix}}}{2 \times L 2 \times tan θ c} \qquad ( Formula 3 )$$

$$\text{?} \text{indicates text missing or illegible when filed}$$

By giving the angle θa corresponding to the angle of view of the imaging device 10 in the case of not providing the optical path bending member 13, the refraction angle θc of light by the optical path bending member 13, and the lengths L1 and L2, it is possible to calculate the angle θb from an inverse function of tan θb obtained by Formula 3. For example, in a case where the length L1=980 mm, the length L2=20 mm, ½ (θa) of the angle of view of the imaging device 10 in the case of not providing the optical path bending member 13 is 20°, and the refraction angle θc of the optical path bending member 13 is 20°, the angle θb is obtained as 0.42°.

That is, it is assumed that the angle of view (that is, the angle of view of lens 102) of the imaging device 10 in the case of not providing the optical path bending member 13 is 2θa=40°. In this case, by providing the optical path bending member 13, it is possible to reduce the angle of view of the imaging device 10 to 2 θb=0.84° without changing the angle of view of the lens 102.

In the imaging device 10, a frame image is generated based on the light reaching the imaging surface 101 through the optical path bending member 13 and the lens 102 as described above, and time series images by the generated frame image are generated. The imaging device 10 is connected to the abnormality determination device 11, and outputs the generated time series images toward the abnormality determination device 11.

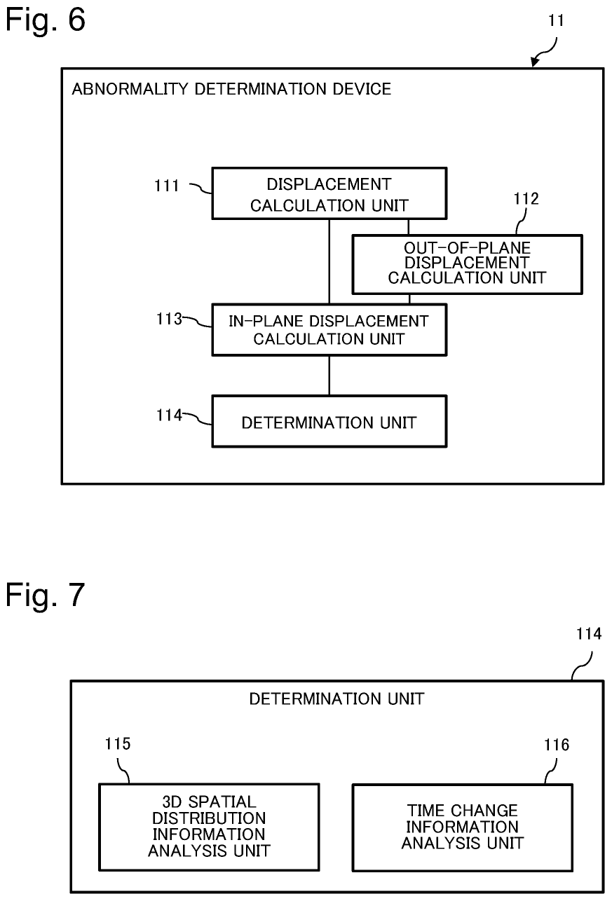

The abnormality determination device 11 includes a function of determining a crack, peeling on the surface of an object 3 to be measured and an internal cavity using the time series images received from the imaging device 10. In the first example embodiment, the abnormality determination device 11 is a computer, and configured to include a processor such as a central processing unit (CPU) and a storage device such as a memory or a hard disk drive (HDD), which is a storage medium. FIG. 6 is a block diagram expressing the functional configuration of the abnormality determination device 11. The abnormality determination device 11 can have a function corresponding to a computer program (hereinafter, also referred to as program) stored in a storage device when the processor executes the computer program. In the first example embodiment, the abnormality determination device 11 includes functional units of a displacement calculation unit 111, an out-of-plane displacement calculation unit 112, an in-plane displacement calculation unit 113, and a determination unit 114 as expressed in FIG. 6.

The displacement calculation unit 111 has a function of calculating (measuring), for each pixel of frame images, for example, displacement (displacement direction and displacement amount) on the surface of the object 3 to be measured between the frame images in the time series images received from the imaging device 10. The frame images to be processed by the displacement calculation unit 111 may be all the frame images included in the time series images, or may be frame images selected for each preset number of frame images, for example, from the time series frame images. By comparing adjacent frame images when the frame images to be processed are arranged in time series, the displacement calculation unit 111 calculates (measures) the displacement of the surface of the object 3 to be measured in the captured image for each pixel of the frame images, for example. Examples of the method for calculating the displacement include a method using image correlation calculation based on a correlation or a change between frame images and a gradient method. When the displacement of the surface of the object 3 to be measured is calculated, a quadratic curve interpolation method may be used in the image correlation calculation. In this case, the displacement calculation unit 111 can calculate the displacement at a level of 1/100 of the array pitch of the imaging elements on the imaging surface 101.

Furthermore, the displacement calculation unit 111 may have a function of generating a displacement distribution map in a two-dimensional space based on the calculated displacement. In a case of including this function, the displacement calculation unit 111 may further include the following function. That is, there is a case where the normal direction of the surface of the object 3 to be measured is not a direction along the optical axis of the lens 102. In this case, by executing perspective projection conversion processing, the displacement calculation unit 111 corrects the displacement according to the deviation in the normal direction of the surface of the object 3 to be measured with respect to the optical axis of the lens 102, and generates the displacement distribution map in the two-dimensional space using the corrected displacement.

Note that for calculating the image correlation, the displacement calculation unit 111 may use the sum of absolute difference (SAD) method, the sum of squared difference (SSD) method, the normalized cross correlation (NCC) method, the zero-mean normalized cross correlation (ZNCC) method, and the like. The displacement calculation unit 111 may use these methods in combination.

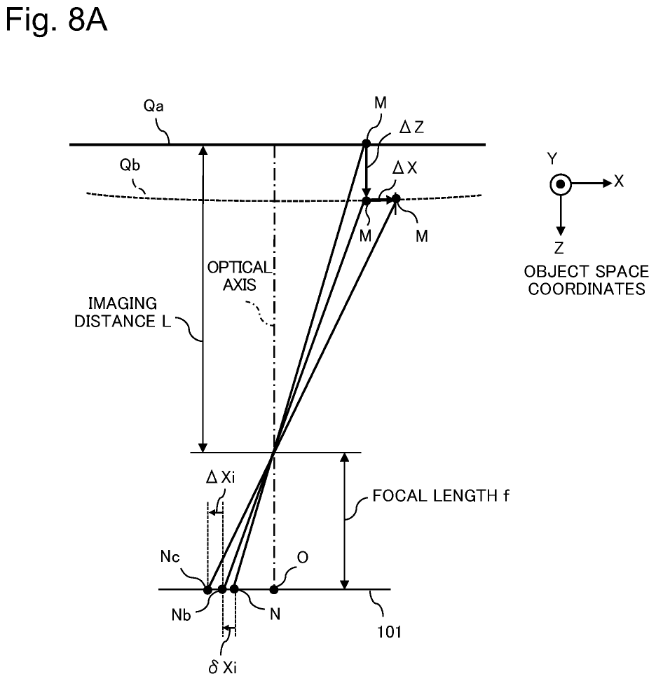

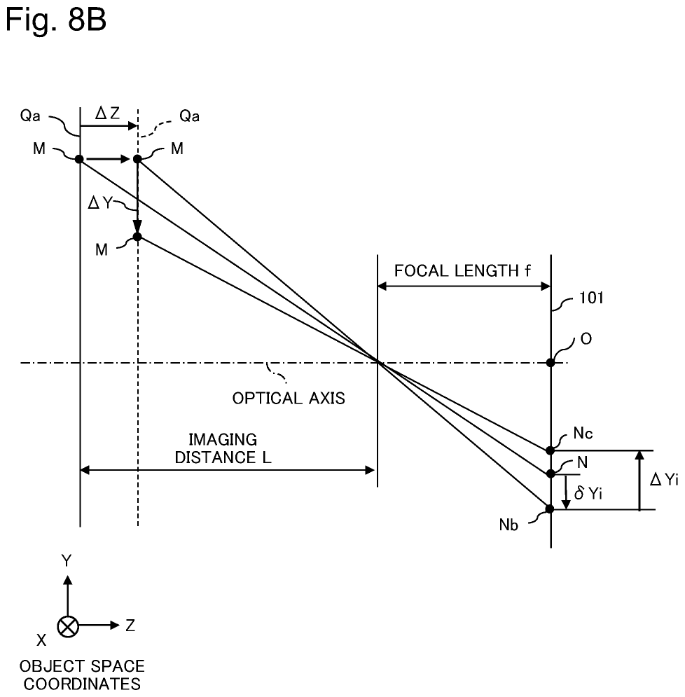

Here, the optical system at the time of imaging the object 3 to be measured by the imaging device 10 will be described with reference to FIGS. 8A and 8B. In FIGS. 8A and 8B, the imaging surface 101 is orthogonal to the optical axis of the lens 102 (not illustrated in FIGS. 8A and 8B) of the imaging device 10, a direction along the optical axis is a Z direction, and two directions orthogonal to each other in the Z direction and parallel to the imaging surface 101 are an X direction and a Y direction. FIG. 8A expresses the optical system on the XZ plane including the optical axis and extending along the X direction and the Z direction, and FIG. 8B expresses the optical system on the YZ plane including the optical axis and extending along the Y direction and the Z direction. The coordinates expressing the position on the imaging surface 101 are expressed using a two-dimensional orthogonal coordinate system with an intersection point with the optical axis as an origin. The coordinate system (here, also referred to as object space coordinates) expressing the position on the surface of the object 3 to be measured conforms to the coordinate system expressing the position on the imaging surface 101. However, since the image of an object is inverted on the imaging surface 101, the positive and negative orientations of the coordinates in the X direction and the Y direction expressing the position on the imaging surface 101 and the coordinates in the X direction and the Y direction in the object space coordinates are set to be opposite to each other.

In FIGS. 8A and 8B, it is assumed that a point M on the surface Qa of the object 3 to be measured is imaged at a point N on the imaging surface 101.

Here, the surface Qa of the object 3 to be measured is displaced in the Z direction by vibration, for example, and the displacement of the point M by vibration is ΔZ. This displacement is out-of-plane displacement. When the point M is displaced in this manner, the image of the point M is displaced from the point N to the position of a point Nb on the imaging surface 101. The displacement due to this displacement is displacement according to out-of-plane displacement. The displacement in the X direction from the point N to the point Nb is expressed as δXi, and the displacement in the Y direction from the point N to the point Nb is expressed as δYi.

The point M on the surface Qa of the object 3 to be measured is displaced by ΔX and ΔY in the X direction and the Y direction, respectively. With this displacement, the image of the point M is captured at the position of a point Nc on the imaging surface 101. The displacement from the point Nb to the point Nc is in-plane displacement. The displacement in the X direction from the point Nb to the point Nc is expressed as ΔXi, and the displacement in the Y direction from the point Nb to the point Nc is expressed as ΔYi.

Here, in FIGS. 8A and 8B, the distance between the main point of the lens 102 and the surface Qa of the object 3 to be measured is an imaging distance L, and the distance between the main point of the lens 102 and the imaging surface 101 is the focal length f. In the surface Qa, the distance between the point M and an origin O in the X direction is X, and the distance between the point M and the origin O in the Y direction is Y. In this case, in the imaging surface 101, the displacement δXi in the X direction of the out-of-plane displacement and the displacement δYi in the Y direction can be expressed by Formula 4. The displacement δXi in the X direction of the in-plane displacement and the displacement ΔYi in the Y direction can be expressed by Formula 5.

$$δ Xi = f \times ( \frac{1}{L - Δ Z} - \frac{1}{L} ) \times X , δ Yi = f \times ( \frac{1}{L - Δ Z} - \frac{1}{L} ) \times Y \qquad ( Formula 4 )$$

$$Δ Xi = \frac{f}{L - Δ Z} \times Δ X , Δ Yi = \frac{f}{L - Δ Z} \times Δ Y \qquad ( Formula 5 )$$

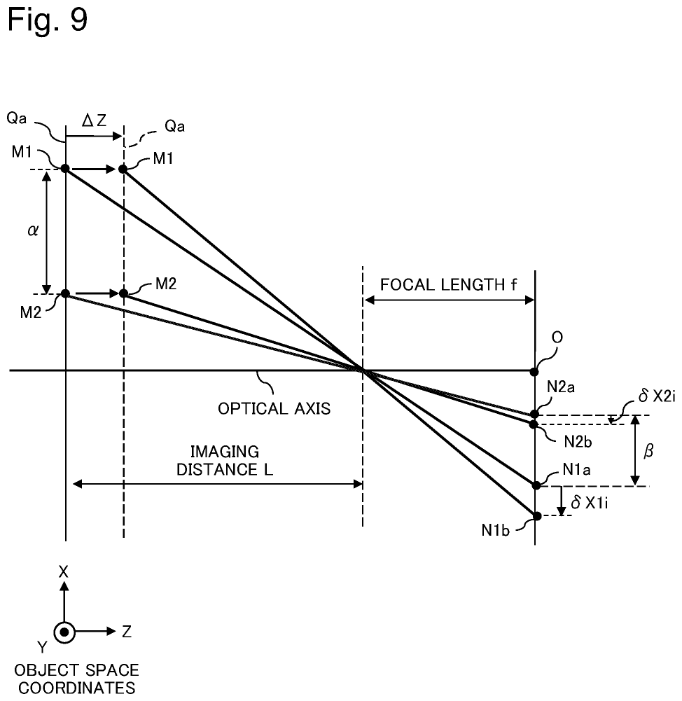

The out-of-plane displacement calculation unit 112 of the abnormality determination device 11 has a function of calculating out-of-plane displacement of the object 3 to be measured as follows using the time series images by the imaging device 10. A method of calculating the out-of-plane displacement will be described with reference to FIG. 9.

As illustrated in FIG. 9, when each of the points M1 and M2 on the surface Qa of the object 3 to be measured is displaced by AZ in the Z direction along the optical axis of the imaging device 10, the out-of-plane displacements of the points M1 and M2 become δX1i and δX2i. Here, the out-of-plane displacement AZ is obtained from Formula 7 using a difference δd between the out-of-plane displacements ιX1i and δX2i illustrated by Formula 6 below. When the distance between the points M1 and M2 on the surface Qa of the object 3 to be measured is α, the distance between an image N1a of the point M1 and an image N2a of the point M2 on the imaging surface 101 is β. β in Formula 7 corresponds to the distance β between the images N1a and N2a. There is a relationship as expressed in Formula 8 between the distance α and the distance β. The difference δd is calculated by the displacement calculation unit 111. The out-of-plane displacement calculation unit 112 calculates the out-of-plane displacement ΔZ based on Formulae 6 and 7.

$$δ d = δ X 2 i - δ X 1 i \qquad ( Formula 6 )$$

$$Δ Z = δ d \times \frac{L}{δ d + β} \qquad ( Formula 7 )$$

$$β = \frac{α \times f}{L} \qquad ( Formula 8 )$$

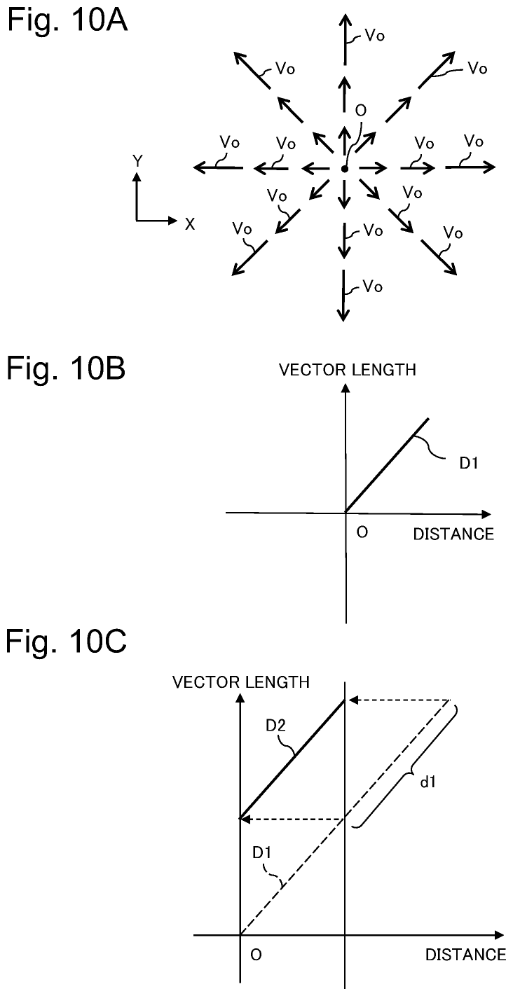

Here, the out-of-plane displacement vector will be described with reference to FIGS. 8A, 10A, and 10B.

Assume that the surface Qa of the object 3 to be measured is uniformly displaced by ΔZ in the Z direction along the optical axis of imaging device 10 as expressed in FIG. 8A. In this case, as expressed in FIG. 10A, an out-of-plane displacement vector Vo on the imaging surface 101 is a radial vector group centered on an intersection point O (in other words, the imaging center) with the optical axis of the imaging device 10. That is, even if the out-of-plane displacement of the surface Qa of the object 3 to be measured is uniform, the length of the out-of-plane displacement vector Vo on the imaging surface 101 becomes longer in proportion to the distance from the imaging center O. In such a case, for example, the relationship between the distance in the X direction from the imaging center O and the length of the out-of-plane displacement vector becomes a relationship as a straight line D1 expressed in the graph of FIG. 10B, and the inclination of this straight line D1 corresponds to the out-of-plane displacement ΔZ.

The out-of-plane displacement calculation unit 112 can calculate the out-of-plane displacement ΔZ also using the length of the out-of-plane displacement vector as described above. That is, the out-of-plane displacement calculation unit 112 may calculate the out-of-plane displacement by performing linear regression calculation on the relationship as expressed in FIG. 10B other than the calculation methods based on Formula 7 and Formula 8.

In the first example embodiment, the imaging device 10 includes the optical path bending member 13. Therefore, in the case of not providing the optical path bending member 13, the optical path becomes as indicated by dotted lines in FIGS. 3 and 4, whereas by providing the optical path bending member 13, the optical path becomes as indicated by solid lines in FIGS. 3 and 4. That is, in the case of not providing the optical path bending member 13, in FIGS. 3 and 4, the point Ja on the surface Qa of the object 3 to be measured is imaged at a point Rc on the imaging surface 101. In FIG. 3, when the point Ja is displaced to the position of a point Jb by, for example, vibration of the surface Qa of the object 3 to be measured, the point Jb is imaged at a point Rd on the imaging surface 101.

On the other hand, by providing the optical path bending member 13, in FIGS. 3 and 4, the point Ja on the surface Qa of the object 3 to be measured is imaged at the point Ra on the imaging surface 101. In FIG. 3, when the point Ja is displaced to the position of a point Jb by, for example, vibration of the surface Qa of the object 3 to be measured, the point Jb is imaged at a point Rb on the imaging surface 101.

In other words, in the case of not providing the optical path bending member 13, the out-of-plane displacement from the point Ja to the point Jb on the surface Qa of the object 3 to be measured expressed in FIG. 3 is expressed as displacement from the point Rc to the point Rd on the imaging surface 101. On the other hand, in the case of providing the optical path bending member 13, the out-of-plane displacement from the point Ja to the point Jb on the surface Qa of the object 3 to be measured is expressed as displacement from the point Ra to the point Rb on the imaging surface 101. By providing the optical path bending member 13 in this manner, the out-of-plane displacement vector on the surface Qa of the object 3 to be measured approaches the optical axis of the lens 102 on the imaging surface 101 as compared with the case of not providing the optical path bending member 13. As described above, even if the out-of-plane displacement of the surface Qa of the object 3 to be measured is uniform, the length of the out-of-plane displacement vector on the imaging surface 101 increases in proportion to the distance from the imaging center O as expressed by the straight line D1 in FIGS. 10B and 10C. By providing the optical path bending member 13, the relationship between the length of the out-of-plane displacement vector and the distance from the imaging center O is as expressed by a solid line D2 in FIG. 10C. That is, the relationship between the length of the out-of-plane displacement vector and the distance from the imaging center O is shifted in a direction in which a d1 part (for example, a part where the distance from the imaging center O of the imaging surface 101 goes beyond the end edge of the imaging surface 101) of the straight line D1 expressed in FIG. 10C approaches the imaging center O, and becomes in a state expressed by a straight line D2. Thus, even if the out-of-plane displacement of the surface Qa of the object 3 to be measured is the same, the length of the out-of-plane displacement vector on the imaging surface 101 becomes longer by providing the optical path bending member 13 than that in the case of not providing the optical path bending member 13. That is, by providing the optical path bending member 13, it is possible to achieve an effect of being capable of improving the measurement resolution of out-of-plane displacement.

When in-plane displacement is sufficiently smaller than out-of-plane displacement, the out-of-plane displacement calculation unit 112 may calculate the out-of-plane displacement as follows. That is, the out-of-plane displacement calculation unit 112 can calculate the out-of-plane displacement ΔZ by calculating Formula 11 by obtaining a coefficient k that minimizes S(k) expressed in Formula 9 and substituting the obtained coefficient k into Formula 11. Note that the coefficient k in Formulae 9 and 11 corresponds to the out-of-plane displacement, and is expressed by Formula 10. Formula 11 is derived from Formula 10.

$$S ( k ) = {\sum }_{xi , yi} {( \sqrt{V x {i}^{2} + V y {i}^{2}} - k \times \sqrt{x {i}^{2} + y {i}^{2}} )}^{2} \qquad ( Formula 9 )$$

Here, i in Formula 9 expresses a number assigned in advance to identify the imaging element constituting the imaging surface 101. Displacement of imaging on the imaging surface 101 according to the displacement of the surface Qa due to vibration or the like of the object 3 to be measured is expressed as a displacement vector Vi. Vxi in Formula 9 expresses an x component of the displacement vector Vi, and Vyi expresses a y component of the displacement vector Vi. Furthermore, xi and yi in Formula 9 are the x component and the y component of the displacement vector on the imaging surface 101 according to the out-of-plane displacement that should be measured in the case of not providing the optical path bending member 13.

$$k = ( \frac{1}{L - Δ Z} - \frac{1}{L} ) \qquad ( Formula 10 )$$

$$Δ Z = \frac{k}{k + 1} \times L \qquad ( Formula 11 )$$

The out-of-plane displacement calculation unit 112 may calculate the out-of-plane displacement ΔZ by the above-described method.

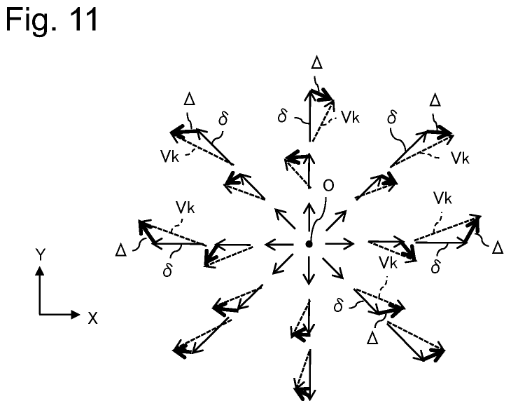

The in-plane displacement calculation unit 113 illustrated in FIG. 6 has a function of calculating in-plane displacement. FIG. 11 is a view explaining the relationship between an out-of-plane displacement vector and an in-plane displacement vector. In FIG. 11, a dotted line Vk expresses the displacement (hereinafter, referred to as measurement vector Vk (Vxᵢ, Vyᵢ)) calculated by the displacement calculation unit 111. The measurement vector Vk (Vxᵢ, Vyᵢ) is a synthetic vector of the out-of-plane displacement vector δ (δxᵢ, δyᵢ) and the in-plane displacement vector Δ (Δxᵢ, Δyᵢ).

The in-plane displacement calculation unit 113 separates the X component of the in-plane displacement vector Δ from the measurement vector Vk by subtracting the X component of the out-of-plane displacement vector δ from the X component of the measurement vector Vk at each point in each section calculated by the displacement calculation unit 111. Although the method of calculating the in-plane displacement in the X direction has been described, in-plane displacement in the Z direction and the Y direction can also be calculated by the same method.

In calculating the out-of-plane displacement by the out-of-plane displacement calculation unit 112 and calculating the in-plane displacement by the in-plane displacement calculation unit 113, an interpolation method using a quadratic curved surface or an equiangular straight line may be used.

The determination unit 114 has a function of detecting an abnormality of the object 3 to be measured based on a time change in displacement of the surface of the object 3 to be measured. In this example, as expressed in FIG. 7, the determination unit 114 includes a three-dimensional spatial distribution information analysis unit 115 and a time change information analysis unit 116. The three-dimensional spatial distribution information analysis unit 115 has a function of analyzing a three-dimensional displacement distribution of the object 3 to be measured at the time point in focus. The time change information analysis unit 116 has a function of analyzing a time change of a three-dimensional displacement in the focused part on the surface of the object 3 to be measured.

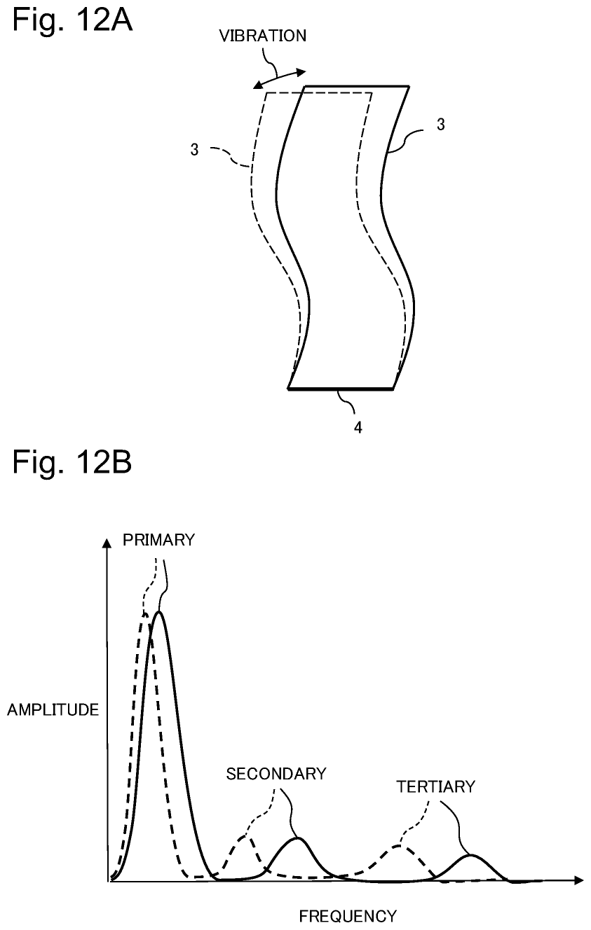

Here, the natural vibration of the object 3 to be measured will be described. FIG. 12A expresses an example of the object 3 to be measured. The object 3 to be measured expressed in FIG. 12A is a cantilever beam, and a fixed end part 4 is fixed. In this example, the object 3 to be measured has a length of 700 millimeters (mm), a width of 150 mm, and a thickness of 3 mm. Furthermore, it is assumed that such the object 3 to be measured vibrates naturally.

It is assumed that such the object 3 to be measured is imaged by the imaging device 10, and displacement (that is, out-of-plane displacement) in a direction in which the object 3 to be measured approaches or moves away from the imaging device 10 due to the natural vibration of the object 3 to be measured is calculated by the out-of-plane displacement calculation unit 112 using the captured image. FIG. 12B expresses the frequency characteristics of the out-of-plane displacement by the natural vibration of the object 3 to be measured. It is assumed that in a case of normally performing natural vibration, the object 3 to be measured has a frequency characteristic of vibration as expressed by a solid line in FIG. 12B, and the primary, secondary, and tertiary natural frequencies are 10 Hz, 50 Hz, and 150 Hz, respectively. The number of the natural vibration of the object 3 to be measured during such normal vibration is stored in advance in a storage device included in the abnormality determination device 11.

On the other hand, in a case where an abnormal part such as an internal cavity exists in the object 3 to be measured, and thus an abnormality occurs in the natural vibration of the object 3 to be measured, the object 3 to be measured has a frequency characteristic of vibration as expressed by a dotted line in FIG. 12B, and has a frequency characteristic different from that at a normal time. As expressed in FIG. 12B, the numbers of the primary, secondary, and tertiary natural frequencies of the object 3 to be measured in the abnormal vibration state tend to be lower than those in the normal state.

Thus, since there is a difference in the frequency characteristic of vibration of out-of-plane displacement of the object 3 to be measured between the normal state and the abnormal state, the abnormality of the object 3 to be measured can be detected by using this frequency characteristic. In consideration of this, in order to detect the vibration state of out-of-plane displacement of the object 3 to be measured, as mentioned above, in the first example embodiment, the frame rate of a moving image of the imaging device 10 is set to 400 fps, which is twice or more of the tertiary natural vibration of 150 Hz in consideration of the sampling theorem. As described above, the frame rate may be appropriately set in consideration of the frequency characteristic of vibration of the object to be measured, and is not limited to 400 fps.

Note that the imaging distance is 1 m, the focal length of the lens of the imaging device is 50 mm, the pixel pitch is 5 μm, and the resolution of 0.1 mm per pixel is achieved. Here, the displacement calculation unit 111 interpolates the displacement up to 1/100 pixels using the quadratic curve interpolation method in the image correlation calculation described above, so that a displacement measurement resolution of 1 μm is achieved.

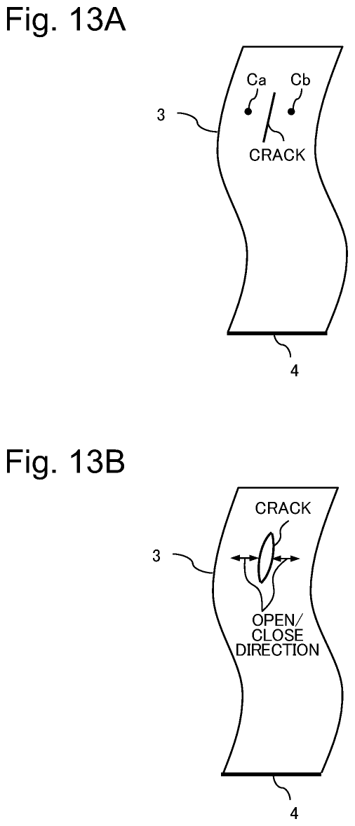

Next, in-plane displacement in a case where a crack is generated as expressed in FIG. 13A on the surface of the object (cantilever) 3 to be measured as described above will be described. In a case where a crack is generated on the surface of the object 3 to be measured, as expressed in FIG. 13B, an opening on the surface of the object 3 to be measured due to the crack is opened and closed due to vibration of the object 3 to be measured. Opening and closing of the opening due to this crack generates in-plane displacement on the surface of the object 3 to be measured.

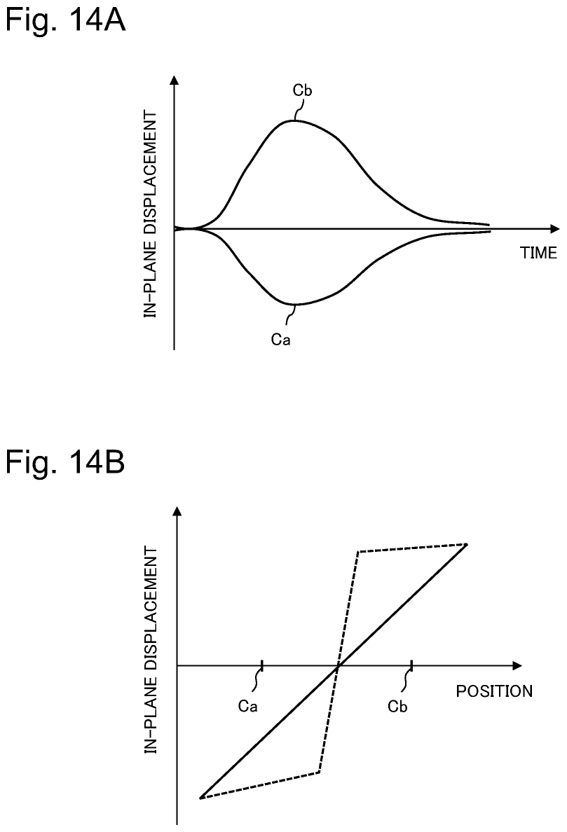

FIG. 14A is a view expressing time change in in-plane displacement at a point Ca and a point Cb, and FIG. 14B is a view illustrating an in-plane displacement distribution on a straight line passing through the point Ca and the point Cb. When there is no crack on the surface of the object 3 to be measured, the spatial in-plane displacement distribution is continuous as illustrated by the solid line in FIG. 14B. On the other hand, when there is a crack, as indicated by the dotted line in FIG. 14B, the spatial in-plane displacement distribution exhibits a rapid intermittent change between the point Ca and the point Cb.

Therefore, based on the time change of the in-plane displacement and the spatial in-plane displacement distribution, it is possible to detect the abnormality of the object 3 to be measured caused by the crack or the like on the surface of the object 3 to be measured.

In consideration of the above, the three-dimensional spatial distribution information analysis unit 115 of the determination unit 114 analyzes the three-dimensional displacement distribution of the object to be measured at multiple time points in focus. The time change information analysis unit 116 analyzes the time change of the three-dimensional displacement in the multiple parts on the surface of the object to be measured. Based on information obtained by the three-dimensional spatial distribution information analysis unit 115 and the time change information analysis unit 116, the determination unit 114 determines an abnormality of the object 3 to be measured. This determination result is output to the notification device 12, for example.

The notification device 12 visually notifies the determination result by, for example, screen display or aurally notifies the same by a speaker or the like. Furthermore, the information output by notification device 12 may be information in a form for reading by a machine other than information in a form visually and aurally recognizable by humans. In the above example, the determination unit 114 determines the abnormality of the object 3 to be measured using both out-of-plane displacement and in-plane displacement. On the other hand, the determination unit 114 may determine the abnormality of the object 3 to be measured using one of out-of-plane displacement and in-plane displacement. In addition to abnormality determination, for example, the determination unit 114 may be used for other purposes such as estimation of the material, using the property that the natural vibration of the vibrator varies depending on the material even in the same dimension, and the notification device may output information according to the purpose.

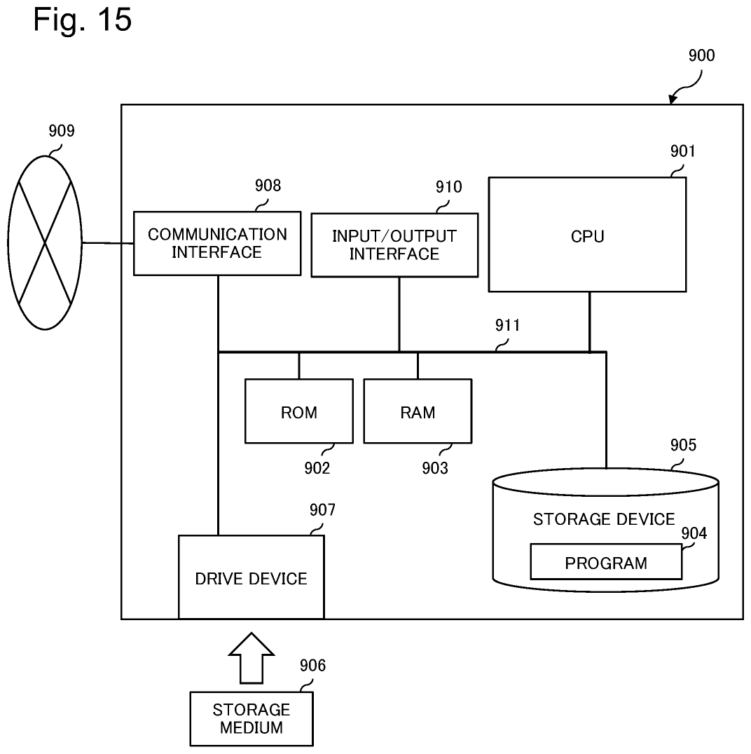

Here, the hardware configuration example of the abnormality determination device 11 will be described. FIG. 15 is a block diagram expressing an example of the hardware configuration of the abnormality determination device 11.

As illustrated in FIG. 15, for example, the abnormality determination device 11 includes a signal processing device (computer device) 900. The signal processing device 900 includes the following configuration as an example.
CPU (Central Processing Unit) 901
ROM (Read Only Memory) 902
RAM (Random Access Memory) 903
Program 904 to be loaded into the RAM 903
Storage device 905 storing the program 904
Drive device 907 that reads and writes a storage medium 906
Communication interface 908 connected with a communication network 909
Input/output interface 910 for inputting/outputting data
Bus 911 connecting constituent elements

The above-described functional units of the abnormality determination device 11 are implemented by the CPU 901 acquiring and executing the program 904 for implementing those functions. The program 904 is stored in advance in the storage device 905 or the ROM 902, for example, and loaded by the CPU 901 into the RAM 903 and executed as necessary. Note that the program 904 may be supplied to the CPU 901 via the communication network 909, or may be stored in advance in the storage medium 906, and the drive device 907 may read and supply, to the CPU 901, the program.

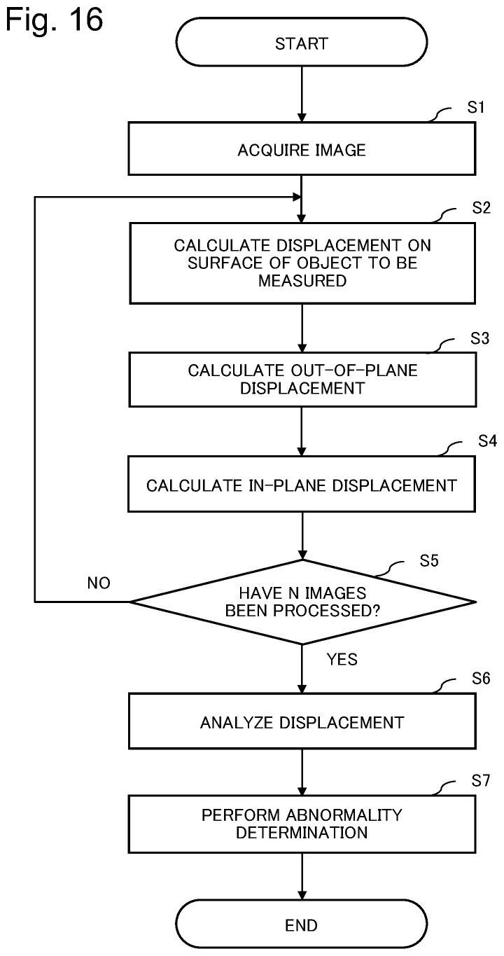

Next, an example of the operation flow of the abnormality determination device 11 will be described with reference to FIG. 16. FIG. 16 is a flowchart illustrating an example of the abnormality determination processing executed by the abnormality determination device 11.

First, the abnormality determination device 11 acquires, from the imaging device 10, time series images in which the surface Qa of the object 3 to be measured is imaged (S1). Then, the displacement calculation unit 111 calculates the displacement on the surface Qa of the object 3 to be measured by using a set of m (m>1) th and m+1 th frame images included in the time series images (S2).

Thereafter, using the displacement obtained by the displacement calculation unit 111, the out-of-plane displacement calculation unit 112 calculates out-of-plane displacement on the surface Qa of the object 3 to be measured (S3). The in-plane displacement calculation unit 113 calculates in-plane displacement by subtracting the out-of-plane displacement by the out-of-plane displacement calculation unit 112 from the displacement by the displacement calculation unit 111 (S4).

After that, the displacement calculation unit 111 determines whether the out-of-plane displacement and the in-plane displacement have been calculated for predetermined n (>1) frame images included in the time series images (S5). When the calculation processing of the out-of-plane displacement and the in-plane displacement has not ended for the n frame images (No in S5), the process returns to step S2, and the displacement calculation unit 111 calculates the displacement on the surface Qa of the object 3 to be measured using the next set of frame images included in the time series images, that is, the m+1 th and the m+2 th frame images.

On the other hand, in step S5, when the displacement calculation unit 111 determines that the calculation processing of the out-of-plane displacement and the in-plane displacement has ended for the n frame images (Yes in S5), the determination unit 114 executes the determination processing. That is, the determination unit 114 analyzes the calculated out-of-plane displacement and calculated in-plane displacement (S6), and, using the analysis result, performs the abnormality determination of the object 3 to be measured (S7). After the abnormality determination, the abnormality determination device 11 outputs the determination result to the notification device 12. According to the notification by the notification device 12, the user can determine, for example, necessity of repair or precise inspection on the object 3 to be measured.

In this manner, the abnormality determination device 11 executes the abnormality determination processing.

As described above, the abnormality determination system 1 of the first example embodiment has the imaging device 10 including the optical path bending member 13. The optical path bending member 13 includes the function of bending the direction of travel of light in a direction approaching the optical axis of the lens 102. As a result, on the imaging surface 101 of the imaging device 10, the length of the part where the out-of-plane displacement of the surface Qa of the object 3 to be measured that is imaged by the imaging device 10 is displayed can be increased as compared with that in the case of not providing the optical path bending member 13. That is, the abnormality determination system 1 in the first example embodiment can improve the measurement resolution of out-of-plane displacement of the surface Qa of the object 3 to be measured. In other words, it is assumed that the angle of view is adjusted by the lens 102 in order to improve the measurement resolution of in-plane displacement of the surface Qa of the object 3 to be measured. As a result, in the case of not providing the optical path bending member 13, the measurement resolution of out-of-plane displacement of the surface Qa of the object 3 to be measured degrades, but the imaging device 10 is provided with the optical path bending member 13, so that the degradation of the measurement resolution of out-of-plane displacement is prevented. Furthermore, in this state, the measurement resolution of out-of-plane displacement can be improved. That is, the abnormality determination system 1 can easily improve the measurement resolution of in-plane displacement and out-of-plane displacement of the surface Qa of the object 3 to be measured.

Therefore, using in-plane displacement and out-of-plane displacement of the surface Qa of the object 3 to be measured having been calculated from the time series images captured by the imaging device 10, the abnormality determination system 1 of the first example embodiment can improve the accuracy of detecting the abnormality of the object 3 to be measured.

The optical path bending member 13 can be retrofitted to the imaging device 10 by including a structure that can be attached to the outside of the lens of the imaging device 10. This makes it possible to attach the optical path bending member 13 to the imaging device 10 constituting an existing abnormality determination system, and the abnormality determination system can be upgraded at low cost to improve detection accuracy without performing large-scale work.

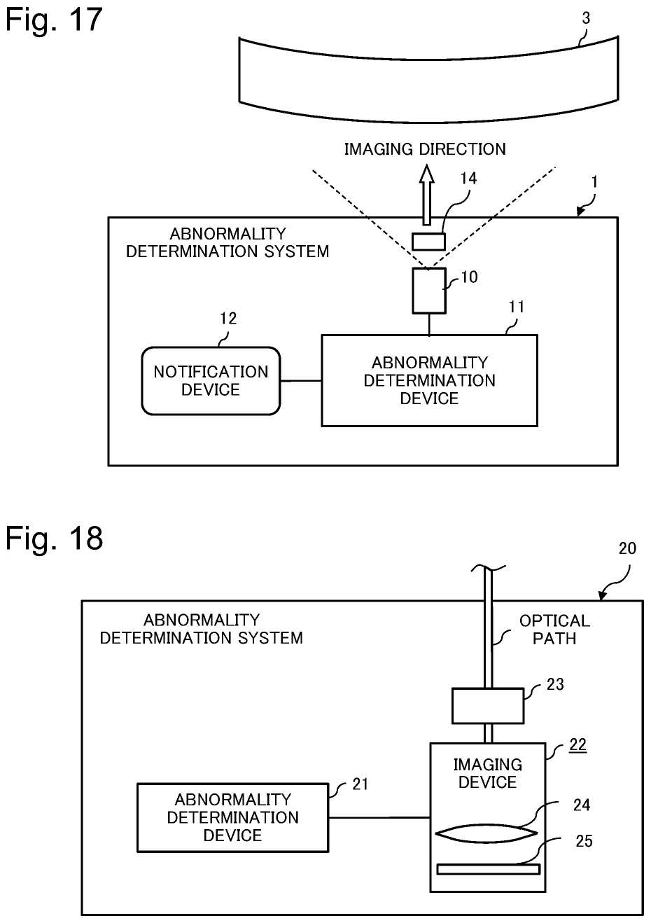

In the first example embodiment, the optical path bending member 13 is a member that is attached to the imaging device 10 and integrated with the imaging device 10. Alternatively, as expressed in FIG. 17, the abnormality determination system 1 may use an optical path bending member 14 separated from the imaging device 10. The optical path bending member 14 is interposed on an optical path from the object 3 to be measured to the imaging device 10. Furthermore, the optical path bending member 13 may be incorporated in the imaging device 10. In this case, the optical path bending member 13 is interposed on the optical path from the light entering the imaging device 10 up to the lens 102.

### Second Example Embodiment

FIG. 18 is a block diagram expressing the configuration of an example embodiment of the abnormality determination system according to the present invention. An abnormality determination system 20 of the second example embodiment includes an abnormality determination device 21, an imaging device 22, and an optical path bending member 23.

The imaging device 22 outputs time series images that include a plurality of captured images that capture over time a surface of an object to be measured.

The optical path bending member 23 is interposed in an optical path part between the object to be measured and a lens 24 on an optical path from the object to be measured to an imaging surface 25 through the lens 24 included in the imaging device 22. The optical path bending member 23 bends light traveling from the lens 24 to the imaging surface 25 so as to tilt light in a direction such that a direction of travel of the light approaches the optical axis of the lens 24. The optical path bending member 23 is configured using, for example, the prism or the mirror as described above.

The abnormality determination device 21 determines an abnormality of the object to be measured using the time series images output from the imaging device 22. That is, the displacement of the surface of the object to be measured is measured from the time series images. Using this measured displacement of the surface of the object to be measured, out-of-plane displacement, which is displacement in the normal direction on the surface of the object to be measured, is calculated. By subtracting the out-of-plane displacement from the measured displacement of the surface of the object to be measured, the in-plane displacement, which is the displacement on the surface of the object to be measured, is calculated. Using the out-of-plane displacement and the in-plane displacement as described above, the abnormality determination device 21 determines the abnormality of the object to be measured. Such the abnormality determination device 21 includes a computer device similarly to the abnormality determination device 11 described above, for example.

The abnormality determination system 20 of the second example embodiment also includes the optical path bending member 23 similar to the optical path bending member 13 in the abnormality determination system 1 of the first example embodiment. Thus, the abnormality determination system 20 can achieve an effect of being capable of easily improving the measurement resolution of both out-of-plane displacement and in-plane displacement.

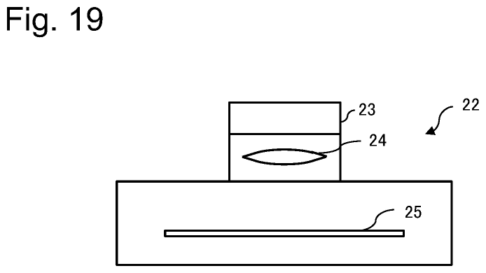

As expressed in FIG. 19, the optical path bending member 23 may constitute the imaging device 22 together with the lens 24 and the imaging surface 25.

The present invention has been described above using the above-described example embodiments as exemplary examples. However, the present invention is not limited to the above-described example embodiments. It will be understood by those of ordinary skill in the art that various aspects may be made therein without departing from the spirit and scope of the present invention as defined by the claims.

### REFERENCE SIGNS LIST

1, 20 abnormality determination system
3 object to be measured
10, 22 imaging device
11, 21 abnormality determination device
13, 14, 23 optical path bending member
24, 102 lens
25, 101 imaging surface

What is claimed is:

1. An abnormality determination system comprising:
an imaging device configured to output time series images that include a plurality of captured images in which a surface of an object to be measured is captured over time;
an optical path bending member that is interposed in an optical path part between the object to be measured and a lens equipped on the imaging device, on an optical path extending from the object to be measured through the lens to an imaging surface, and is configured to bend light traveling from the lens to the imaging surface so as to tilt light in a direction such that a direction of travel of the light approaches an optical axis of the lens; and
an abnormality determination device including at least one processor, the at least one processor being configured to determine an abnormality of the object to be measured using out-of-plane displacement and in-plane displacement, the out-of-plane displacement being displacement in a normal direction on a surface of the object to be measured and being calculated using displacement of the surface of the object to be measured that is measured from the time series images, the in-plane displacement being displacement on the surface of the object to be measured and being calculated by subtracting the out-of-plane displacement from displacement of the surface of the object to be measured that has been measured.

2. The abnormality determination system according to claim 1, wherein the optical path bending member is provided integrally with the imaging device.

3. The abnormality determination system according to claim 1, wherein the optical path bending member is a member separate from the imaging device, and is interposed in an optical path part between the object to be measured and the imaging device.

4. An imaging device comprising:
an imaging surface for capturing an image of a surface of an object to be measured;
a lens configured to guide light from an outside to the imaging surface; and
an optical path bending member that is interposed in an optical path part between the object to be measured and the lens on an optical path extending from the object to be measured through the lens to the imaging surface, and is configured to bend light traveling from the lens to the imaging surface so as to tilt light in a direction such that a direction of travel of the light approaches an optical axis of the lens.

5. An abnormality determination method comprising:
interposing an optical path bending member configured to bend light traveling from a lens equipped on an imaging device to an imaging surface equipped on the imaging device so as to tilt the light in a direction such that a direction of travel of the light approaches an optical axis of the lens in an optical path part between the lens and a surface of the object to be measured, the imaging device outputting time series images that include a plurality of captured images in which the surface of the object to be measured is captured over time; and
determining, by a computer, an abnormality of the object to be measured using out-of-plane displacement and in-plane displacement, the out-of-plane displacement being displacement in a normal direction on a surface of the object to be measured and being calculated using displacement of a surface of the object to be measured that is measured from the time series images based on light having traveled the imaging surface through the optical path bending member and the lens in order, the in-plane displacement being displacement on a surface of the object to be measured and being calculated by subtracting the out-of-plane displacement from displacement of the surface of the object to be measured that is measured.
